(19) United States
(12) Patent Application Publication
(10) Pub. No.: US 2009/0075641 A1
(43) Pub. Date: Mar. 19, 2009

(54) AUTOMATED OVER-THE-AIR FIRMWARE UPDATE FOR A WIRELESS PHONE

(75) Inventors: MESUT GUVEN, ALLEN, TX (US); MALCOLM LORANG, DALLAS, TX (US)

Correspondence Address: HOWISON & ARNOTT, L.L.P, P.O. BOX 741715, DALLAS, TX, 75374-1715, US

(73) Assignee: METROPCS WIRELESS, INC., DALLAS, TX (US)

(21) Appl. No.: 11/857,090

(22) Filed: Sep. 18, 2007

(51) Int. Cl. H04B 1/08

(52) U.S. Cl. 455/419

(57) ABSTRACT

A method for providing over-the-air updates of firmware of a mobile telephone handset comprises the steps of receiving at least one firmware update at a server. A determination of a need for updates is made at the mobile telephone handset and a point-to-point communications channel is established between the server and the mobile telephone handset responsive to a determination of the need for updates at the mobile telephone handset. The at least one firmware update is then downloaded to the mobile telephone handset from the server.

### TECHNICAL FIELD

The present invention relates to firmware updates for wireless phones, and more particularly, to over-the-air firmware updates for wireless telephones.

### BACKGROUND

Wireless telephones include firmware for controlling operations and functionalities for providing interactions with the wireless communications network. Currently, there are two different methods for updating firmware on mobile telephone handsets using FOTA (firmware over-the-air) via an OMA DM (Open Mobile Alliance Download Management) server. The first method, as illustrated in FIG. 1, involves the transmission of a message such as a WAP push notification 102 from the OMA DM server 104 to the mobile telephone handset 106. The WAP push notification 102 is transmitted to certain handsets 106 based upon the model number associated with the handset. A response 108 is transmitted back from the handsets 106 to the OMA DM server 104 in response to the WAP push notification. The response indicates whether or not the handset 106 wishes to download the firmware update. Upon acceptance of the update by the user of the handset 106, the firmware update is downloaded from the OMA DM server 104 to the handset 106 over an established connection.

Referring now to FIG. 2, there is illustrated a second embodiment of a prior art method wherein a user initiated request is used for the update. In this method, a handset 202 includes a FOTA client user interface 204. The FOTA client user interface 204 enables a user to initiate a query 206 to the OMA DM server 208. The query 206 asks the OMA DM server 208 whether or not software/firmware updates are presently available for the particular handset 202 initiating the query 206. The OMA DM server 208 determines if an update for the firmware exists and transmits a response 210 from the OMA DM server 208 back to the handset 202. The response notifies the FOTA client user interface 204 whether an update exists for the handset 202. This enables the user to make a determination as to whether to download an available update.

These types of firmware updates require a great deal of traffic across the wireless telephone network interconnecting the OMA DM servers and the handsets since specific call connections are needed. Thus, some method for minimizing the number of over-the-air communications between the OMA DM server and the handsets would greatly improve the firmware update procedures of the handset and provide greater network bandwidth.

### SUMMARY

The present invention disclosed and claimed herein, in one aspect thereof, comprises a method for providing over-the-air updates of the firmware of a mobile telephone handset. The process involves receiving at least one firmware update at a server. A determination is made of the need for updates at a mobile telephone handset. A point-to-point communications channel is established between the server and the mobile telephone handset responsive to a determination of a need for updates at the mobile telephone handset. The at least one firmware update is then downloaded to the mobile telephone handset from the server.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a prior art general broadcast method for firmware updates;

FIG. 2 illustrates a prior art user initiated query method for updating firmware.

FIG. 3 illustrates the interconnection of an OMA DM server and multiple handsets via a wireless network;

FIG. 4 is a flow diagram illustrating a first embodiment for over-the-air updating of handsets;

FIG. 5 illustrates a second embodiment for over-the-air updating of handsets;

FIG. 6 illustrates a third embodiment for over-the-air updating of handsets;

FIG. 7 illustrates a fourth embodiment for over-the-air updating of handsets;

FIG. 8 illustrates a fifth embodiment for over-the-air updating of handsets; and

FIG. 9 illustrates a sixth embodiment for over-the-air updating of handsets.

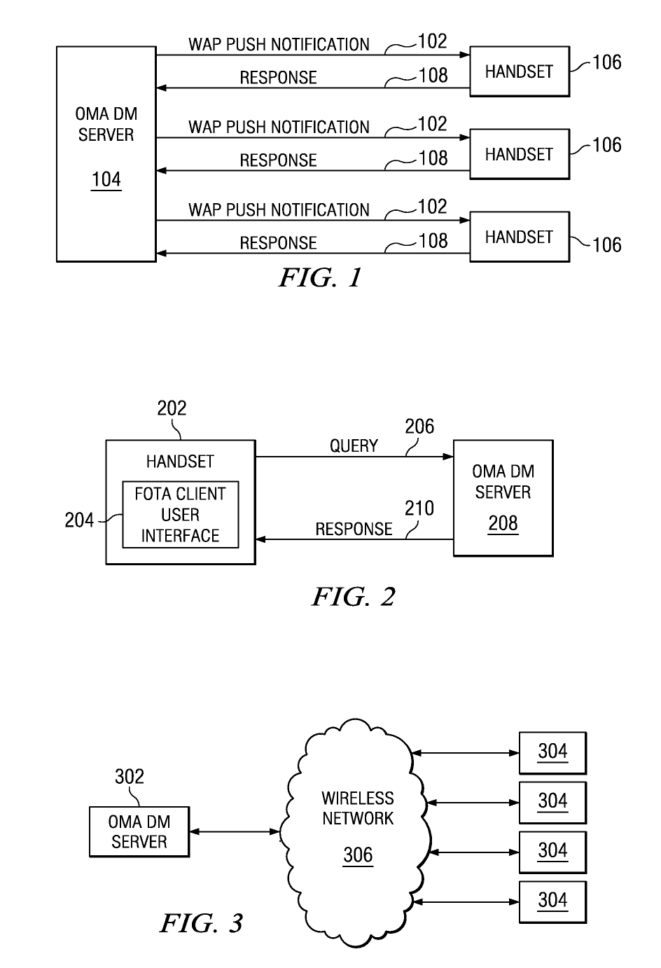

### DETAILED DESCRIPTION

Referring now to the drawings, wherein like reference numbers are used herein to designate like elements throughout the various views, embodiments of the present disclosure are illustrated and described, and other possible embodiments of the present disclosure are described. The figures are not necessarily drawn to scale, and in some instances the drawings have been exaggerated and/or simplified in places for illustrative purposes only. One of ordinary skill in the art will appreciate the many possible applications and variations of the present disclosure based on the following examples of possible embodiments of the present disclosure.

Referring now to the drawings, and more particularly to FIG. 3, there is illustrated the operating environment of the system of the present disclosure. An OMA DM (Open Mobile Alliance Download Management) server 302 may communicate with multiple wireless telephone handsets 304 over a wireless network 306. The wireless network 306 may comprise any type of known wireless communication system such as GSM, CDMA, TDMA, 3G or other known or developed wireless communication network systems. The wireless handset devices 304 would comprise any devices capable of communicating over these networks that had associated therewith various firmware that could be updated via the OMA DM server 302.

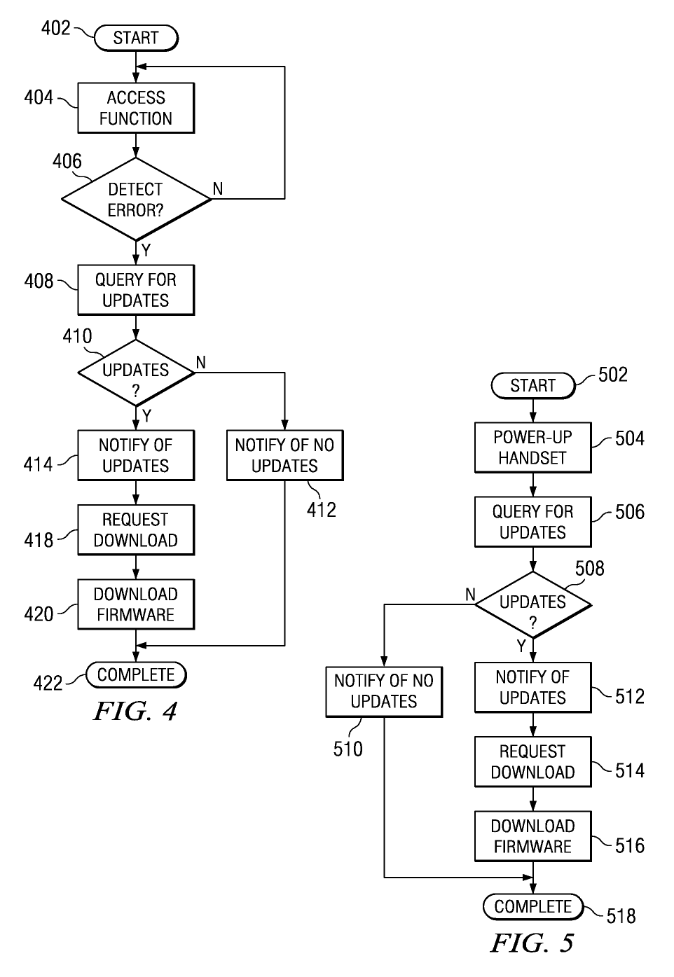

The present system rather than using WAP push and SMS point-to-point communications which each require the establishment of traffic channels to individual handsets 304 from the OMA DM server 302 thus requiring a great deal of communication bandwidth upon the network to be utilized describes various methods that minimize system traffic while still providing the ability to keep a handset updated with the latest firmware revisions in order to prevent adverse operating effects to applications upon the handset. The system uses various types of automated update procedures which may be initiated either by the OMA DM server 302 or the handset 304 in order to provide the most up-to-date firmware available for the handset. The methods enable direct data connections between the OMA DM server to only be generated when a firmware update is available and needed by the handset 304. This will assist in greatly reducing the amount of traffic over the wireless network 306 and provide for improved system capacity. Various methods for implementing the improved firmware over-the-air updates are described with respect to FIGS. 4-9.

Referring now to FIG. 4, there is illustrated a first embodiment for over-the-air update of firmware wherein the handset checks for updates each time an error is encountered while the handset 304 is processing an application or client. Once this process is initiated at step 402, the particular function being processed by the wireless handset 304 is accessed at step 404. Inquiry step 406 determines if there is an error detected during execution of the function at step 404. If no error is detected at step 406, a next function may be accessed back at step 404. When inquiry step 406 detects an error during execution of a function, an IP data connection is established between the handset 304 and the OMA DM server 302 through the wireless network 306 in order to query for updates from the OMA DM server 302 at step 408. Alternatively, the process may wait to establish the IP data connection until a specified number of critical errors have been detected. The errors detected at inquiry step 406 may comprise various feature errors related to operation of the messaging client, the operation of SMS or MMS messaging, instant messaging, email or browser/client issues. Other errors such as call processing errors, low level errors in operation of handset or any other errors correctable by firmware are also applicable.

Once the handset has queried the OMA DM server 302 at step 408, the OMA DM server 302 checks for updates related to the error at inquiry step 410. The check for updates may be made at particular established times of the day or week. For example, the process can check for updates at the same time or times each day during off-peak hours. The process can also check at one particular time each week in order to control access for RF bandwidth reasons. If the OMA DM server 302 determines there are no available updates for the error, the handset 304 is notified of the availability of no updates at step 412 via the established IP connection through the wireless network 306. If the OMA DM server 302 determines at inquiry step 410 that updates do exist, the handset 304 is notified at step 414 of the existence of updates to the detected error through the established IP connection. The handset 304 may request a download of the applicable update at step 418, and the OMA DM server 302, responsive to the request, downloads the updated firmware to the handset 304 at step 420 over the established IP connection. Alternatively, the download could occur at a particular time of the day (i.e., during off-peak hours) or week (to assist with bandwidth) as discussed above. Once the firmware has been downloaded to the handset 304 or the handset has been notified of the existence of no updates at step 412, the process is completed at step 422.

Referring now to FIG. 5, there is illustrated an alternative embodiment for updating the firmware within a mobile handset 304 wherein the handset checks for updates to the firmware each time it is powered on. The process is initiated at step 502 and upon power up of the handset at step 504; a query is made to the OMA DM server 302 at step 506. The OMA DM server 302 determines at inquiry step 508 whether updates exist for the handset 304. The query from the handset 304 to the OMA DM server 302 will include the model number of the handset 304 to enable the OMA DM server to determine whether any updates exist for the handset 304. If inquiry step 508 determines that no updates exist, the handset 304 is notified at step 510 of the existence of no updates and the process is completed at step 518. If the OMA DM server 302 determines at inquiry step 508 that updates exist for the handset 304, the handset is notified of the presence of updates at step 512. The handset 304 may request download of the firmware update at step 514. The request for download initiates the creation of an IP connection between the handset 304 and the OMA DM server 302 via the wireless network 306 enabling the firmware to be downloaded to the handset 304 at step 516. Alternatively, the download could occur at a particular time of the day (i.e., during off-peak hours) or week (to assist with bandwidth) as discussed above. Once the firmware has been downloaded to the handset 304, the process is completed at step 518.

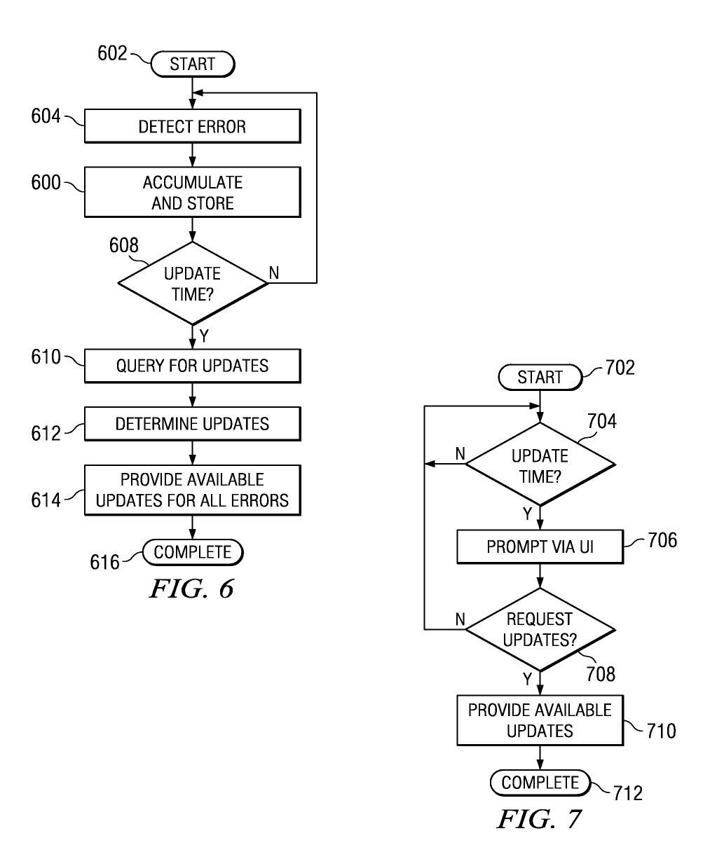

Referring now to FIG. 6, there is illustrated a further embodiment for an over-the-air firmware update wherein the handset accumulates and filters multiple errors and then initiates a single data session to communicate the multiple errors and request updates related to the errors. The process is initiated at step 602 and when an error is detected within the operations of the handset at step 604 this error is noted and an accumulation of detected errors is stored at step 606. Part of the accumulation and storage process involves the storage of diagnostic data relating to the detected errors that will enable the OMA DM server 302 to better determine the update necessary for correcting the error when an update is finally requested. The stored diagnostic data would be cross indexed to the applicable detected error.

Inquiry step 608 determines if it is time to request available updates for repairing the accumulated errors. The time to request update can be based upon a time of day in order to enable the use of off-peak time periods; the time of the week; a number of critical errors threshold or any other appropriate parameter indicating a time for update request. If not, control passes back to step 604 for the detection of further errors. Once inquiry step 608 determines that it is time to request updates for the accumulated errors, a query is sent at step 610 from the handset 304 to the OMA DM server 302 over the wireless network. The query will also include the accumulated diagnostic data relating to the detected errors. The OMA DM server 302 determines at step 612 whether updates exist for any of the accumulated errors and may utilize the provided diagnostic data in order to make these determinations. The available updates for the detected errors are provided back to the handset 304 at step 614 by the OMA DM server 302. The process is complete at step 616.

Referring now to FIG. 7, there is illustrated yet a further embodiment when updates are achieved by periodically prompting a user via a user interface within the handset 304 to check for new firmware updates that may be available from the OMA DM server 302. The process is initiated at step 702 and inquiry step 704 determines whether the time period to prompt a user to request an update has arrived. If not, the process continues to cycle through inquiry step 704 until a determination is made that it is time to prompt the user. Once inquiry step 704 determines that the update time has arrived, the user is prompted at step 706 via a graphical user interface to check for new firmware updates from the OMA DM server 302 other error interfaces may be used. Inquiry step 708 determines whether the user initiates a request for firmware updates. If not, control passes back to step 704 to monitor for the next update time. If the user requests the available updates, the OMA DM server 302 establishes an IP connection with the handset 304 via the wireless network 306 and downloads all available updates to the handset 304 at step 710. The process is completed at step 712 and may return to monitoring for the next update period.

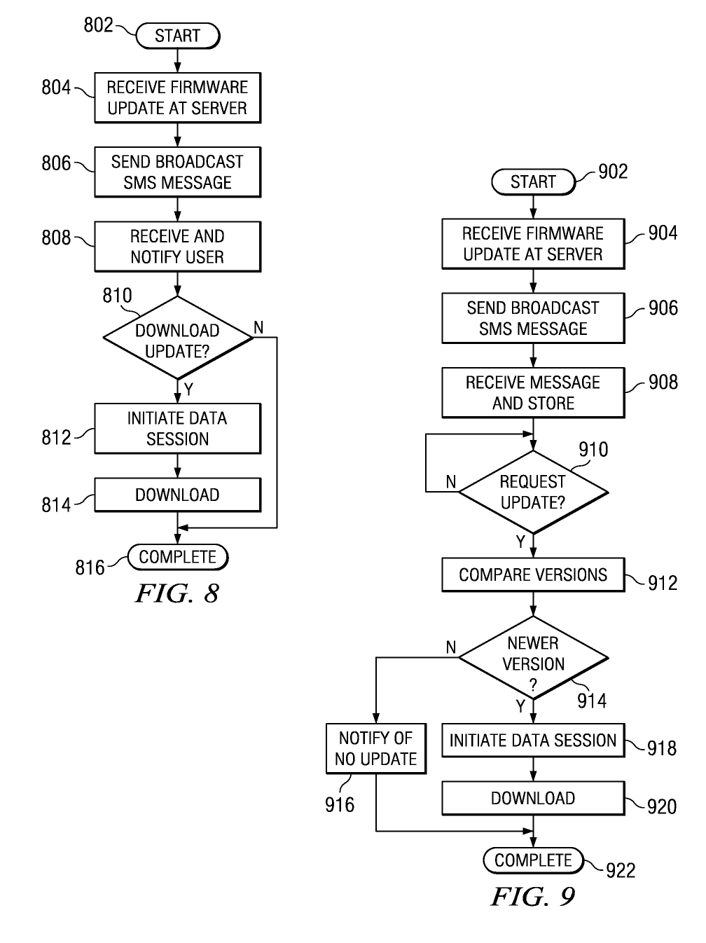

Referring now to FIG. 8, there is illustrated yet a further embodiment for updating the firmware of a handset 304 using an over-the-air connection. This embodiment utilizes the broadcast of an SMS message by the OMA DM server 302 upon receipt of new firmware updates at the server. The process is initiated at step 802 and upon receipt of a firmware update at the OMA DM server 302 at step 804, the OMA DM server 302 generates an SMS broadcast message at step 806 for transmission to all of the handsets 403 via the wireless network notifying the handsets 304 of the available update. The SMS broadcast message will include identifying information enabling the handsets 304 to make a determination as to whether or not the firmware update is applicable to a particular handset 304.

While the present description has been made with respect to the use of an SMS broadcast message other methods and protocols for the wide broadcast of data to the multiple handsets 304 to notify them of the available firmware updates may be utilized. The SMS message that is broadcast to the handsets 304 may be performed in accordance with the CDMA 2000 over-the-air standards. The handsets 304 for which the SMS message is intended receive and decipher the message such that their respective users may be notified at step 808 of an available update. Inquiry step 810 enables a determination of whether the user requests download of the update. If not, the process is completed at step 816. If the user requests download of the firmware update, the handset establishes at step 812 a data session with the OMA DM server over the wireless network 306. Through an IP data connection, the firmware update is downloaded to the handset 304 at step 814.

A final embodiment for providing an over-the-air firmware update is illustrated in FIG. 9. This embodiment also utilizes a broadcast SMS message that is transmitted using the CDMA 2000 standard over the wireless network 306. As mentioned before, other broadcast protocols may be used. The process is initiated at step 902, and the OMA DM server 302 receives a firmware update at step 904. The OMA DM server 302 broadcasts the SMS message at step 906 according to the CDMA 2000 standard or as described previously using any other broadcast protocol in order to provide the information to the variety of handset units from the OMA DM server 302. The broadcast message includes a version number for the update that has been received at the OMA DM server 302. The handsets 304 receive the broadcast message and store at step 908 the firmware update version number associated with the firmware update broadcast by the OMA DM server 302. Inquiry step 910 then monitors for whether a FOTA client user interface within the handset 304 initiates a firmware update. If no firmware update initiation is detected, inquire step 910 will continue to monitor for the firmware update request.

Once a firmware update is initiated, the handset 304 compares the current firmware version of the handset with the version stored from the earlier broadcast SMS notification from the OMA DM server 302. If it is determined at inquiry step 914 that the available version from the OMA DM server is newer than the present version on the handset 304, the handset 304 will initiate a data session with the OMA DM server 302 and download the newer version of the update at step 920. If the handset version is the same or newer than the version available from the server 302, the process is completed at step 922 and no update is initiated.

The above described system and method for over-the-air updates of firmware within a handset 304 provides a number of advantages over existing over-the-air update methods. The described processes eliminate the need for the OMA DM server 302 to transmit unnecessary messages to handsets that are not experiencing any particular error issues with applications within that handset. This enables a reduction in network messaging and can increase the wireless system communications capacity. By limiting the number of network messages the data traffic from user handset 304 is minimized by limiting the number of users trying to check for updates. Automation of the process increases the overall efficiency of the firmware update process and helps to ensure that handsets are provided with updates only when necessary. This prevents handsets from becoming obsolete. By providing notifications of errors to the OMA DM server 302, OEM's and/or carrier servers may be notified of issues that are found during the lifetimes of their handsets. By providing periodic firmware updates to the handsets 304 the effective lifetime of the handsets may be increased. Updating of the firmware also assists in eliminating calls by customers to the carrier for many software/firmware related issues that will be automatically fixed by the periodic firmware updates. Lack of errors caused by the updated firmware will also increase customer satisfaction in the handset, thus increasing customer loyalty to the carrier.

It will be appreciated by those skilled in the art having the benefit of this disclosure that this invention provides an improved method for firmware over-the-air updates to mobile handsets. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method for providing over the air updates of firmware of a mobile telephone handset, comprising the steps of:
receiving at least one firmware update at a server;
determining a need for updates at the mobile telephone handset;
establishing a point to point communications channel between the server and the mobile telephone handset responsive to a determination of the need for updates at the mobile telephone handset; and
downloading the at least one firmware update to the mobile telephone handset from the server.

2. The method of claim 1, wherein the step of determining further comprises the steps of detecting at least one error during an execution of an application within the mobile telephone handset.

3. The method of claim 2, further including the steps of:
storing the at least one detected error at the mobile telephone handset;
determining if a regularly occurring period of time has expired for the mobile telephone handset;
querying for updates to correct the at least one error upon expiration of the regularly occurring period of time.

4. The method of claim 3, wherein the query includes diagnostic information relating to the at least one detected error.

5. The method of claim 3, further including the step of determining which of the at least one firmware updates will correct the at least one detected error.

6. The method of claim 5, wherein the step of determining further comprises the step of determining which of the at least one firmware update will correct the at least one detected error responsive to diagnostic information included within the query.

7. The method of claim 6, wherein the step of downloading further comprises the step of downloading the at least one firmware updates determined to correct the at least one detected error.

8. The method of claim 2, further including the steps of:
querying for an availability of the at least one firmware update at the server responsive to the detection of the at least one error in the mobile telephone handset;
providing an indication to the mobile telephone handset of the of an availability of the at least one firmware update.

9. The method of claim 8, wherein the step of downloading further includes the step of downloading the at least one firmware update responsive to a user request to download the update.

10. The method of claim 1, wherein the step of determining further comprises the steps of:
detecting a power-up condition in the mobile telephone handset;
querying for an availability of the at least one firmware update at the server responsive to the detection of the power-up condition.

11. The method of claim 10, further including the step of providing an indication to the mobile telephone handset of an availability of the at least one firmware update.

12. The method of claim 11, wherein the step of downloading further includes the step of downloading the at least one firmware update responsive to a user request to download the update.

13. The method of claim 1, wherein the step of determining further comprises the steps of:
determining if a regularly occurring period of time has expired for the mobile telephone handset;
prompting a user via a user interface to request an update; and
querying for updates to the server responsive to a request from the user.

14. The method of claim 13, wherein the step of downloading further includes the step of downloading the at least one firmware update responsive to the user query generated responsive to the prompt via the user interface.

15. The method of claim 1, further including the step of generating a broadcast message to a plurality of mobile telephone handsets indicating availability of the at least one firmware update.

16. The method of claim 15, wherein the broadcast message comprises an SMS broadcast message.

17. The method of claim 15, wherein the step of determining further comprises the steps of:
receiving the general broadcast message at the mobile telephone handset;
determining the at least one firmware update referenced in the general broadcast message applies to the mobile telephone handset;
requesting download of the at least one firmware update to the mobile telephone handset.

18. The method of claim 15, wherein the broadcast message further includes a version number of the at least one firmware update.

19. The method of claim 18, wherein the step of determining further comprises the steps of:
receiving the general broadcast message at the mobile telephone handset;
determining the at least one firmware update referenced in the general broadcast message applies to the mobile telephone handset;
storing the version number associated with the at least one firmware update at the mobile telephone handset if the at least one firmware update applies to the mobile telephone handset;
determining if a regularly occurring period of time has expired for the mobile telephone handset;
comparing a version number of a presently installed firmware update with the stored version number of the at least one firmware update;
requesting download of the at least one firmware update if the version number of the at least one firmware update is newer than the version number of the presently installed firmware update.

20. A method for providing over the air updates of firmware of a mobile telephone handset, comprising the steps of:
receiving at least one firmware update at a server;
detecting at least one error during an execution of an application within the mobile telephone handset;
querying for an availability of the at least one firmware update at the server responsive to the detection of the at least one error in the mobile telephone handset;
establishing a point to point data channel between the server and the mobile telephone handset to download the at least one firmware update handset; and
downloading the at least one firmware update to the mobile telephone handset from the server over the point to point data channel.

21. The method of claim 20, further including the steps of storing the at least one detected error at the mobile telephone handset.

22. The method of claim 21, wherein the step of querying further comprises the steps of:
determining if a regularly occurring period of time has expired for the mobile telephone handset;
querying for the availability of the at least one update at the server upon expiration of the regularly occurring period of time.

23. The method of claim 22, wherein the query includes diagnostic information relating to the at least one detected error.

24. The method of claim 23, further including the step of determining which of the at least one firmware update will correct the at least one detected error.

25. The method of claim 24, wherein the step of determining further comprises the step of determining which of the at least one firmware update will correct the at least one detected error responsive to diagnostic information included within the query.

26. The method of claim 25, wherein the step of downloading further comprises the step of downloading the at least one firmware updates determined to correct the at least one detected error.

27. The method of claim 20, wherein the step of querying further comprises the steps of querying for the availability of the at least one update at the server responsive to detection of the at least one error.

28. The method of claim 27, further including the step of providing an indication to the mobile telephone handset of the of an availability of the at least one firmware update responsive to the query.

29. The method of claim 28, wherein the step of downloading further includes the step of downloading the at least one firmware update responsive to a user request to download the update.

30. A method for providing over the air updates of firmware of a mobile telephone handset, comprising the steps of:
receiving at least one firmware update at a server;
generating an SMS broadcast message to a plurality of mobile telephone handsets indicating availability of the at least one firmware update
receiving the SMS broadcast message at the mobile telephone handset;
determining the at least one firmware update referenced in the SMS broadcast message applies to the mobile telephone handset;
requesting download of the at least one firmware update to the mobile telephone handset;
establishing a point to point communications channel between the server and the mobile telephone handset responsive to a determination of a need for updates at the mobile telephone handset; and
downloading the at least one firmware update to the mobile telephone handset from the server.

31. The method of claim 30, wherein the SMS broadcast message further includes a version number of the at least one firmware update.

32. The method of claim 31, wherein the step of determining further comprises the steps of:
determining the at least one firmware update referenced in the general broadcast message applies to the mobile telephone handset;
storing the version number associated with the at least one firmware update at the mobile telephone handset if the at least one firmware update applies to the mobile telephone handset;
comparing a version number of a presently installed firmware update with the stored version number of the at least one firmware update;
requesting download of the at least one firmware update if the version number of the at least one firmware update is newer than the version number of the presently installed firmware update.

33. A method for providing over the air updates of a firmware of a mobile telephone handset, comprising the steps of:
detecting a power-up condition in the mobile telephone handset;
querying for an availability of at least one firmware update at a server responsive to the detection of the power-up condition;
providing an indication to the mobile telephone handset of an availability of the at least one firmware update;
establishing a point to point communications channel between the server and the mobile telephone handset responsive to a request for the available at least one firmware update from the mobile telephone handset; and
downloading the at least one firmware update to the mobile telephone handset from the server.

34. The method of claim 11, wherein the step of downloading further includes the step of downloading the at least one firmware update responsive to a user request to download the update.

35. A method for providing over the air updates of a firmware of a mobile telephone handset, comprising the steps of:
receiving at least one firmware update at a server;
determining if a regularly occurring period of time has expired for the mobile telephone handset;
prompting a user via a user interface to request an update;
querying for updates to the server responsive to a request from the user;
establishing a point to point communications channel between the server and the mobile telephone handset responsive to a determination of a need for updates at the mobile telephone handset; and
downloading the at least one firmware update to the mobile telephone handset from the server.

36. The method of claim 35, wherein the step of downloading further includes the step of downloading the at least one firmware update responsive to the user query generated responsive to the prompt via the user interface.
